(19) United States
(12) Patent Application Publication
(10) Pub. No.: US 2018/0135991 A1
(43) Pub. Date: May 17, 2018

(54) INDOOR NAVIGATION SYSTEM AND INDOOR NAVIGATION METHOD

(71) Applicant: Aengin Technology Inc., Taipei City (TW)

(72) Inventors: Kai-Chieh Yang, Taipei City (TW); Yi-Hsiang Chen, Taipei City (TW); Ning-Chain Hsu, Taipei City (TW); Yi-Hsuang Chen, Taipei City (TW)

(73) Assignee: Aengin Technology Inc., Taipei City (TW)

(21) Appl. No.: 15/814,397

(22) Filed: Nov. 16, 2017

Related U.S. Application Data
(60) Provisional application No. 62/423,161, filed on Nov. 16, 2016.

(51) Int. Cl. G01C 21/34; H04W 4/02; G01C 21/28

(52) U.S. Cl. CPC G01C 21/3415; H04L 67/26; G01C 21/28; H04W 4/02

(57) ABSTRACT

An indoor navigation system and an indoor navigation method are provided. The system includes a plurality of first signal transmitting devices and a first electronic device. The first signal transmitting devices are deployed at a first place and transmit a plurality of first signals respectively. The first electronic device is held by a user. The first electronic device obtains a destination location in the first place. The first electronic device detects a second signal transmitted by a second signal transmitting device in the first signals. The first electronic device obtains a first path from a first position adjacent to the second signal transmitting device to the destination location according to the second signal and the destination location. The first electronic device outputs the first path to inform the user of the first electronic device.

### CROSS-REFERENCE TO RELATED APPLICATION

This application claims the priority benefit of U.S. prior application Ser. No. 62/423,161, filed on Nov. 16, 2016. The entirety of the above-mentioned patent application is hereby incorporated by reference herein and made a part of this specification.

### BACKGROUND OF THE INVENTION

### Field of the Invention

The invention relates to a navigation system, and particularly relates to an indoor navigation system.

### Description of Related Art

Generally, when a person is in a strange indoor environment, the person cannot immediately learn a layout of the indoor environment, and cannot immediately know how to move forward to a specific destination location in the indoor environment. Therefore, how to quickly and accurately perform indoor navigation is one of problems to be resolved by related technicians of the art.

### SUMMARY OF THE INVENTION

The invention is directed to an indoor navigation system and an indoor navigation method, by which a user is able to quickly learn a destination location in a strange indoor environment.

The invention provides an indoor navigation system. The indoor navigation system includes a plurality of first signal transmitting devices and a first electronic device. The first signal transmitting devices are deployed at a first place and transmit a plurality of first signals respectively. The first electronic device is held by a user. The first electronic device obtains a destination location in the first place. The first electronic device detects a second signal transmitted by a second signal transmitting device in the first signals. The first electronic device obtains a first path from a first location adjacent to the second signal transmitting device to the destination location according to the second signal and the destination location. The first electronic device outputs the first path to inform the user of the first electronic device.

In an embodiment of the invention, before the first path from the first location adjacent to the second signal transmitting device to the destination location is obtained, the first electronic device obtains a plurality of first location information of the first signal transmitting devices, and displays a plurality of second locations of the first signal transmitting devices deployed at the first place according to the first location information.

In an embodiment of the invention, the indoor navigation system further includes a server. The server stores the first location information of the first signal transmitting devices. The first electronic device obtains the first location information of the first signal transmitting devices from the server.

In an embodiment of the invention, the first path passes through a plurality of third signal transmitting devices in the first signal transmitting devices.

In an embodiment of the invention, the first electronic device detects a third signal transmitted by a fourth signal transmitting device in the first signals. The first electronic device determines whether the user moves along the first path according to the third signal. When the user does not move along the first path, the first electronic device obtains a second path from a third location adjacent to the fourth signal transmitting device to the destination location according to the third signal and the destination location. The first electronic device outputs the second path to inform the user of the first electronic device.

In an embodiment of the invention, the first electronic device displays a push message according to the second signal.

In an embodiment of the invention, the first signal is a beacon signal.

The invention provides an indoor navigation method adapted to an indoor navigation system. The indoor navigation system includes a plurality of first signal transmitting devices and a first electronic device. The first signal transmitting devices are deployed at a first place and transmit a plurality of first signals respectively. The first electronic device is held by a user. The indoor navigation method includes: obtaining a destination location in the first place by the first electronic device; detecting a second signal transmitted by a second signal transmitting device in the first signals by the first electronic device; obtaining a first path from a first location adjacent to the second signal transmitting device to the destination location by the first electronic device according to the second signal and the destination location; and outputting the first path to inform the user of the first electronic device by the first electronic device.

In an embodiment of the invention, before the step of obtaining the first path from the first location adjacent to the second signal transmitting device to the destination location, the indoor navigation method further includes: obtaining a plurality of first location information of the first signal transmitting devices by the first electronic device, and displaying a plurality of second locations of the first signal transmitting devices deployed at the first place according to the first location information.

In an embodiment of the invention, the indoor navigation system further includes a server. The indoor navigation method further includes: storing the first location information of the first signal transmitting devices by the server; and obtaining the first location information of the first signal transmitting devices from the server by the first electronic device.

In an embodiment of the invention, the first path passes through a plurality of third signal transmitting devices in the first signal transmitting devices.

In an embodiment of the invention, the indoor navigation method further includes: detecting a third signal transmitted by a fourth signal transmitting device in the first signals by the first electronic device; determining whether the user moves along the first path by the first electronic device according to the third signal; when the user does not move along the first path, obtaining a second path from a third location adjacent to the fourth signal transmitting device to the destination location by the first electronic device according to the third signal and the destination location; and outputting the second path to inform the user of the first electronic device by the first electronic device.

In an embodiment of the invention, the indoor navigation method further includes: displaying a push message by the first electronic device according to the second signal.

In an embodiment of the invention, the first signal is a beacon signal.

According to the above description, the invention provides an indoor navigation system and an indoor navigation method, by which a user is able to quickly learn a destination location in a strange indoor environment.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of an indoor navigation system according to an embodiment of the invention.

FIG. 2A is a schematic diagram of an electronic device according to an embodiment of the invention.

FIG. 2B is a schematic diagram of a server according to an embodiment of the invention.

FIG. 2C is a schematic diagram of a signal transmitting device according to an embodiment of the invention.

FIG. 3A to FIG. 3B are schematic diagrams of an application of an indoor navigation system according to an embodiment of the invention.

FIG. 4 is a schematic diagram of displaying a push message according to an embodiment of the invention.

FIG. 5 is a flowchart illustrating an indoor navigation method according to an embodiment of the invention.

### DESCRIPTION OF EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

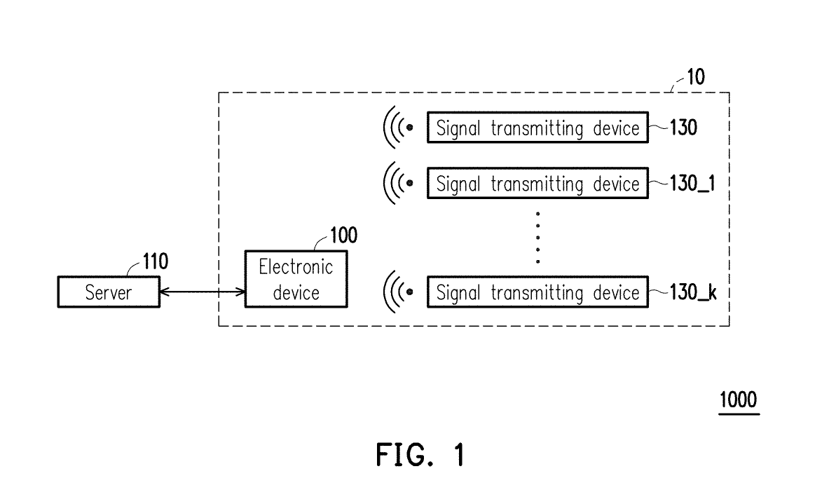

FIG. 1 is a schematic diagram of an indoor navigation system according to an embodiment of the invention.

Referring to FIG. 1, in the present exemplary embodiment, the indoor navigation system 1000 includes an electronic device 100, a server 110 and signal transmitting devices 130-130_k. The electronic device 100 is adapted to communicate with the server 110 through a wired or wireless network. Moreover, in the present exemplary embodiment, it is assumed that the signal transmitting devices 130-130_k (which are also referred to as first signal transmitting devices) are deployed at a place 10 (which is also referred to as a first place). The place 10 is, for example, an indoor environment. The signal transmitting devices 130-130_k respectively transmit a plurality of signals (which are also referred to as first signals). The electronic device 100 may receive (or detect) at least one of the signals transmitted by the signal transmitting devices 130-130_k. It should be noted that the invention is not limited to the amounts of the electronic device, the server and the signal transmitting devices in the indoor navigation system 1000.

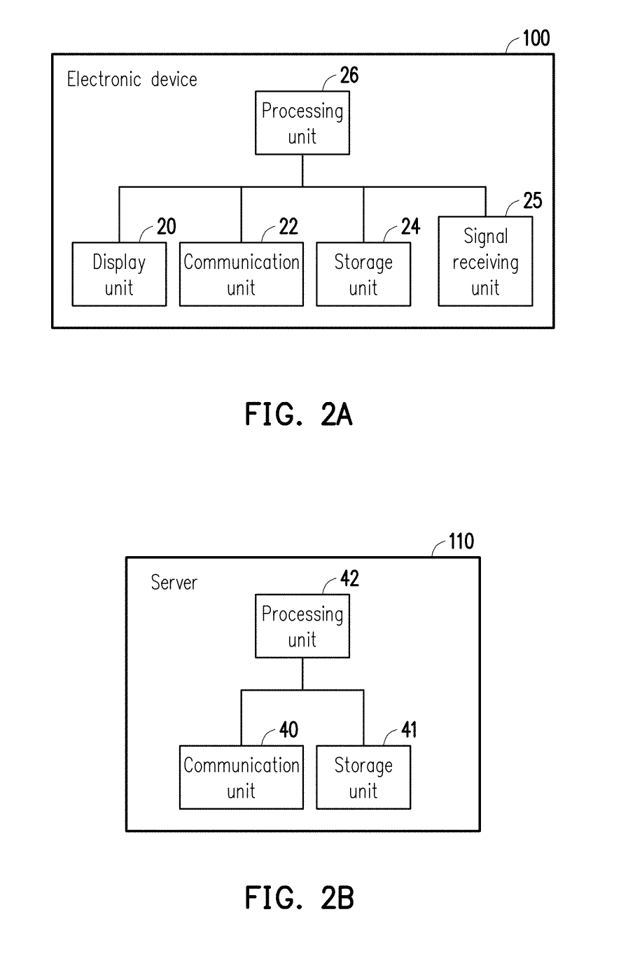

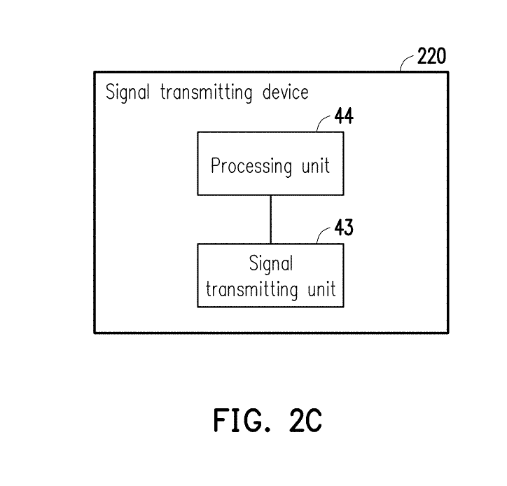

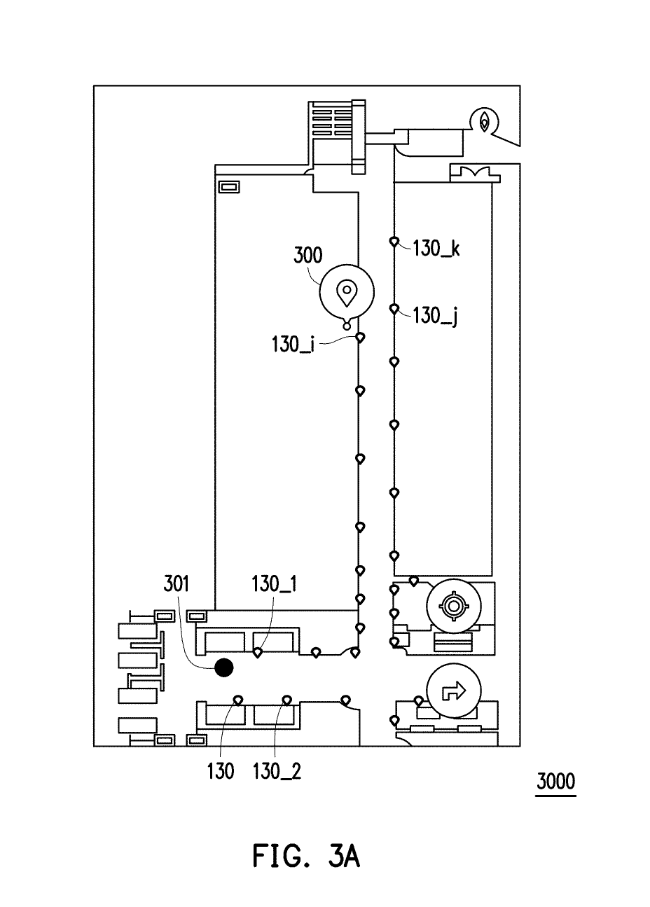

FIG. 2A is a schematic diagram of an electronic device according to an embodiment of the invention.

Referring to FIG. 2A, the electronic device 100 includes a display unit 20, a communication unit 22, a storage unit 24, a signal receiving unit 25 and a processing unit 26. The display unit 20, the communication unit 22, the storage unit 24 and the signal receiving unit 25 are respectively coupled to the processing unit 26. The electronic device 200 is, for example, an electronic mobile device such as a mobile phone, a tablet computer, a notebook computer, etc., which is not limited by the invention.

The display unit 20 may be a display device used for providing a display function in a display region of the electronic device 100. The display unit 20 may be a display device used for providing the display function such as a liquid crystal display (LCD), a light-emitting diode (LED), a field emission display (FED), etc.

The communication unit 22 may be a signal transmitting device supporting a global system for mobile communication (GSM) system, a personal handy-phone system (PHS), a code division multiple access (CDMA) system, a wideband code division multiple access (WCDMA) system, a long term evolution (LTE) system, a worldwide interoperability for microwave access (WiMAX) system, a wireless fidelity (Wi-Fi) system or Bluetooth, etc.

The storage unit 24 may be any type of a fixed or movable random access memory (RAM), a read-only memory (ROM), a flash memory, or a similar device or a combination thereof.

The signal receiving unit 25 may be used for receiving (or detecting) the signals transmitted by at least one of the signal transmitting devices 130-130_k. In the present exemplary embodiment, the signal receiving unit 50 is a signal receiver used for receiving beacon signals. However, the invention is not limited thereto, and the signal receiving unit 25 may also be signal receivers used for receiving (or sensing) other types of signals.

The processing unit 26 may be a central processing unit (CPU), or other programmable general purpose or special purpose microprocessor, a digital signal processor (DSP), a programmable controller, an application specific integrated circuit (ASIC) or other similar devices or a combination of the aforementioned devices.

In the present exemplary embodiments, the storage unit 24 of the electronic device 100 stores a plurality of program instructions, and the program instructions are loaded to and executed by the processing unit 26. For example, the storage unit 24 includes a plurality of modules, and the modules are respectively used for executing various operations of the electronic device 100 applied to the indoor navigation system 1000, where each of the modules is composed of one or a plurality of program instructions. However, the invention is not limited thereto, and various operations of the electronic device 100 may also be implemented through other hardware forms.

FIG. 2B is a schematic diagram of a server according to an embodiment of the invention.

Referring to FIG. 2B, the server 110 includes a communication unit 40, a storage unit 41 and a processing unit 42. The communication unit 40 and the storage unit 41 are respectively coupled to the processing unit 42. The communication unit 40, the storage unit 41 and the processing unit 42 may be devices similar to the aforementioned communication unit 22, the storage unit 24 and the processing unit 26, and details thereof are not repeated.

In the present exemplary embodiment, the storage unit 41 of the server 110 stores a plurality of program instructions, and the program structions are loaded to and executed by the processing unit 42. For example, the storage unit 41 includes a plurality of modules, and the modules are respectively used for executing various operations of the server 110 applied to the indoor navigation system 1000, where each of the modules is composed of one or a plurality of program instructions. However, the invention is not limited thereto, and various operations of the server 110 may also be implemented through other hardware forms.

FIG. 2C is a schematic diagram of a signal transmitting device according to an embodiment of the invention. It should be noted that since the signal transmitting devices 130-130_k in FIG. 1 are substantially similar devices, a signal transmitting device 220 is taken as an example to describe the required devices of the electronic device.

Referring to FIG. 2C, the signal transmitting device 220 includes a signal transmitting unit 43 and a processing unit 44. The signal transmitting unit 43 is coupled to the processing unit 44. The processing unit 44 may be a device similar to the aforementioned processing unit 26, and detail thereof is not repeated.

The signal transmitting unit 43 is a transmitter used for transmitting signals, and a signal transmitted by the transmitter may include an identification code, where the identification code is, for example, used for identifying a location of the signal transmitting device 220 deployed in the place 10. In the present exemplary embodiment, the signal transmitting unit 43 is a signal transmitter used for transmitting beacon signals. However, the invention is not limited thereto, and the signal transmitting unit 43 may also be signal transmitters used for transmitting other types of signals.

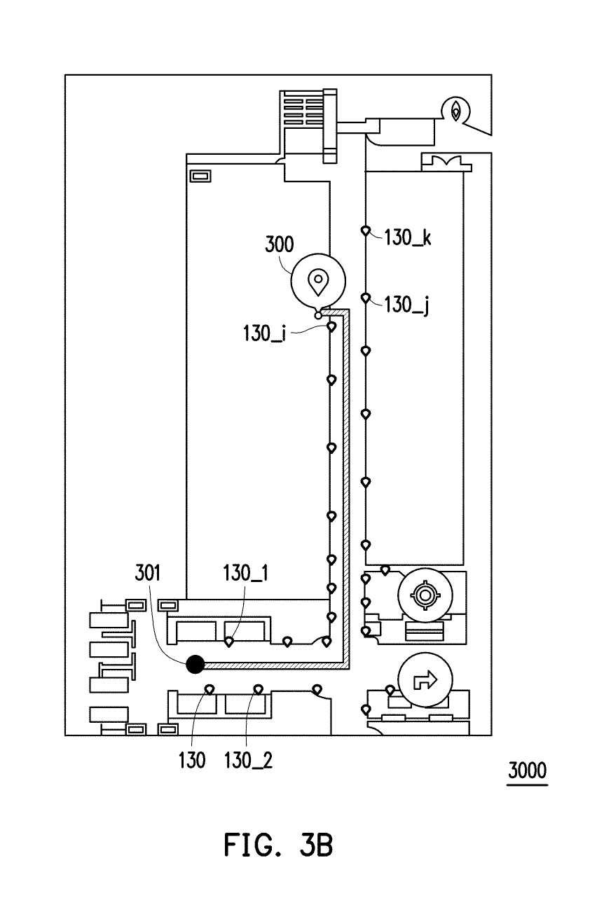

FIG. 3A to FIG. 3B are schematic diagrams of an application of the indoor navigation system according to an embodiment of the invention.

Referring to FIG. 3A, in the indoor navigation system 1000 of the invention, it is assumed that the signal transmitting devices 130-130_k are respectively disposed at two sides of a passageway of the place 10, and may respectively (and continuously) transmit signals. Moreover, the server 110 may also store location information (which is also referred to as first location information) of the signal transmitting devices 130-130_k, where the first location information, for example, includes information of a plurality of locations (which are also referred to as second locations) where the signal transmitting devices 130-130_k are respectively deployed in the place 10. The first location information may record locations of each of the signal transmitting devices and identification codes of the signals transmitted by each of the signal transmitting devices.

As shown in FIG. 3A, in the present exemplary embodiment, the electronic device 100 may obtain a plane graph 3000 of the place 10 and the aforementioned first location information from the server 110. Particularly, the electronic device 100 may display a plurality of locations in the plane graph 3000 where the signal transmitting devices 130-130_k are respectively deployed in the place 10 according to the first location information. Then, a user may select a destination location 300 in the plane graph 3000 displayed by the electronic device 100. Namely, the electronic device 100 may obtain the destination location in the place 10.

Particularly, the electronic device 100 may detect the signals transmitted by at least one of the signal transmitting devices 130-130_k. For example, it is assumed that the user is currently located at a location 301 (which is also referred to as a first location), and the electronic device 100 may detect the signal (which is also referred to as a second signal) transmitted by the signal transmitting device 130 (which is also referred to as a second signal transmitting device).

After the electronic device 100 obtains the destination location 300 input by the user and detects the aforementioned second signal, referring to FIG. 3B, the electronic device 100 may obtain (or decide) a path (which is also referred to as a first path) from a user current location 301 to the destination location 300 according to the second signal and the destination location 300, and displays the path in the plane graph 3000. Namely, the electronic device 100 may output the decided first path in the plane graph 3000 to inform the user of the electronic device 100. Thereafter, the user may move forward to the destination location 300 according to the first path displayed in the plane graph 3000.

It should be noted that in the present exemplary embodiment, since the electronic device 100 has obtained the first location information from the server 110, the electronic device 100 may learn that the user current location 301 is adjacent to the signal transmitting device 130 according to the identification code of the second signal and the first location information. Particularly, in the present exemplary embodiment, the first path decided by the electronic device 100 passes through the signal transmitting devices 130-130_i (which are also referred to as third signal transmitting devices) in the signal transmitting devices 130-130_k. Namely, there are signal transmitting devices in the path decided by the electronic device 100. When the user holds the electronic device 100 to move along the first path, the electronic device 100 may continuously detect the signals transmitted by the signal transmitting devices in the first path.

After the aforementioned first path is decided, when the user holds the electronic device 100 to move in the place 10, the electronic device 100 may continuously detect the signals transmitted by the signal transmitting devices along the way during a moving process, and the electronic device 100 may determine whether the user moves along the aforementioned first path according to the detected signals.

For example, it is assumed that the electronic device 100 detects a signal (which is also referred to as a third signal) transmitted by a fourth signal transmitting device during the moving process of the user. The electronic device 100 may determine a user current location (i.e. a location adjacent to the fourth signal transmitting device) and whether the user current location is on the first path according to the identification code in the third signal and the first location information obtained from the server 110. In other words, the electronic device 100 may determine whether the user moves along the first path according to the above mentioned third signal.

When the electronic device 100 determines that the user current location is not on the first path, the electronic device 100 may determine that the user does not move along the first path. Now, the electronic device 100 may re-obtain (or re-decide) a path (which is also referred to as a second path) from the location adjacent to the fourth signal transmitting device (which is also referred to as the third location) to the destination location 300 according to the aforementioned third signal and the destination location 300. Thereafter, the electronic device 100 may output the above mentioned second path in the manner of FIG. 3B to inform the user of the electronic device 100 how to move forward to the destination location from the user current location.

In other words, when the user does not move along the predetermined first path, the electronic device 100 may dynamically decide a second path to replace the original first path, such that the user may move forward to the destination location from the user current location.

It should be noted that in an exemplary embodiment of the invention, when the electronic device 100 senses (or receives) a signal transmitted by a signal transmitting device, it is assumed that the signal carries specific information, the electronic device 100 may display a push message according to the received signal, such that the user immediately learns the specific message carried by the signal.

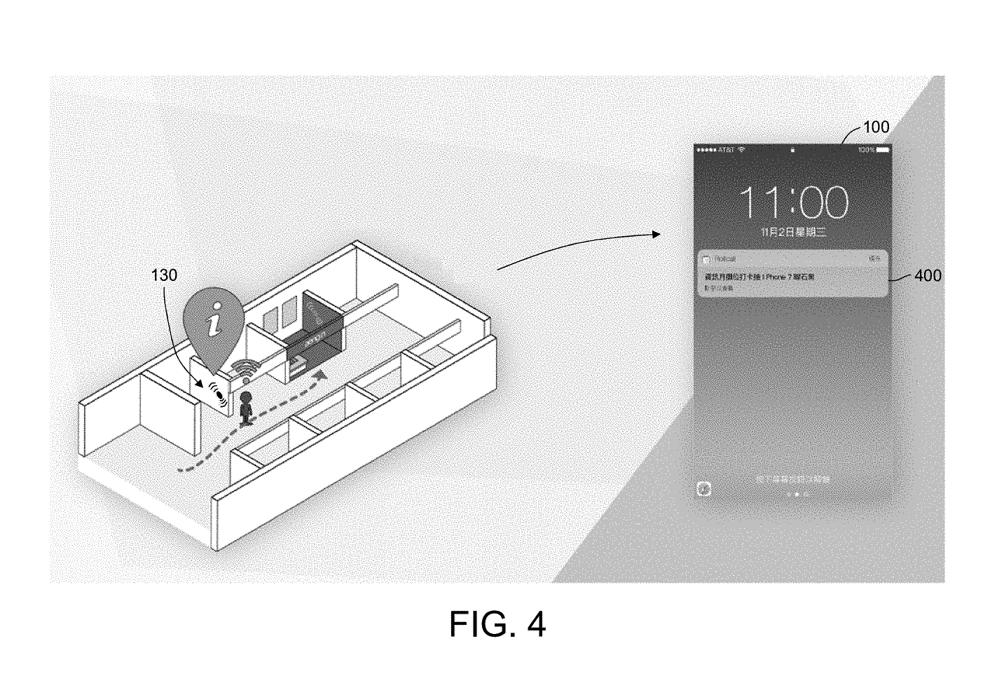

For example, FIG. 4 is a schematic diagram of displaying a push message according to an embodiment of the invention.

Referring to FIG. 4, in case that the user holds the electronic device 100 to move, it is assumed that the electronic device 100 senses (or receives) a signal transmitted by the signal transmitting device 130, and the signal carries specific information, the electronic device 100 may display a push message 400 according to the received signal such that the user may immediately learn the specific information carried by the signal. For example, if the place 10 is a place where an exhibition is held, and the signal transmitting device 130 is deployed at a booth, the signal transmitting device 130 may transmit an advertising message of the booth to the electronic device 100 held by the user, and the electronic device 100 may immediately display the advertising message of the booth. Moreover, according to the aforementioned embodiment of FIG. 3A and FIG. 3B, the user may also quickly learn a destination location in the place holding the exhibition, and may move forward to the destination location according to a recommended path.

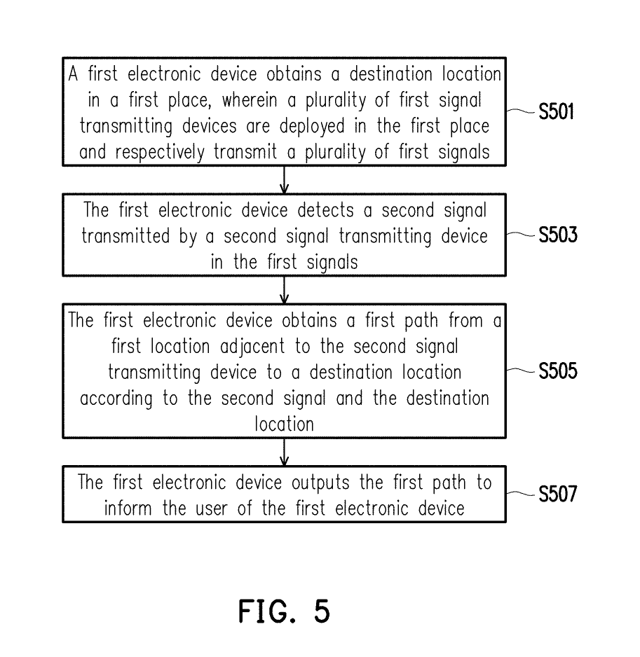

FIG. 5 is a flowchart illustrating an indoor navigation method according to an embodiment of the invention.

Referring to FIG. 5, in step S501, a first electronic device obtains a destination location in a first place, wherein a plurality of first signal transmitting devices are deployed in the first place and respectively transmit a plurality of first signals. In step S503, the first electronic device detects a second signal transmitted by a second signal transmitting device in the first signals. In step S505, the first electronic device obtains a first path from a first location adjacent to the second signal transmitting device to a destination location according to the second signal and the destination location. In step S507, the first electronic device outputs the first path to inform the user of the first electronic device.

In summary, the invention provides an indoor navigation system and an indoor navigation method, by which the user may quickly learn the destination location in a strange indoor environment, and the electronic device may display the corresponding push message according to the received signal during the moving process.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An indoor navigation system, comprising:
a plurality of first signal transmitting devices, deployed at a first place, and transmitting a plurality of first signals respectively; and
a first electronic device, held by a user, wherein
the first electronic device obtains a destination location in the first place.
the first electronic device detects a second signal transmitted by a second signal transmitting device in the first signals,
the first electronic device obtains a first path from a first location adjacent to the second signal transmitting device to the destination location according to the second signal and the destination location, and
the first electronic device outputs the first path to inform the user of the first electronic device.

2. The indoor navigation system as claimed in claim 1, wherein before the first path from the first location adjacent to the second signal transmitting device to the destination location is obtained,
the first electronic device obtains a plurality of first location information of the first signal transmitting devices, and displays a plurality of second locations of the first signal transmitting devices deployed at the first place according to the first location information.

3. The indoor navigation system as claimed in claim 2, further comprising:
a server, storing the first location information of the first signal transmitting devices,
wherein the first electronic device obtains the first location information of the first signal transmitting devices from the server.

4. The indoor navigation system as claimed in claim 1, wherein
the first path passes through a plurality of third signal transmitting devices in the first signal transmitting devices.

5. The indoor navigation system as claimed in claim 1, wherein
the first electronic device detects a third signal transmitted by a fourth signal transmitting device in the first signals,
the first electronic device determines whether the user moves along the first path according to the third signal,
when the user does not move along the first path, the first electronic device obtains a second path from a third location adjacent to the fourth signal transmitting device to the destination location according to the third signal and the destination location, and
the first electronic device outputs the second path to inform the user of the first electronic device.

6. The indoor navigation system as claimed in claim 1, wherein
the first electronic device displays a push message according to the second signal.

7. The indoor navigation system as claimed in claim 1, wherein the first signal is a beacon signal.

8. An indoor navigation method, adapted to an indoor navigation system, wherein the indoor navigation system comprises a plurality of first signal transmitting devices and a first electronic device, the first signal transmitting devices are deployed at a first place and transmit a plurality of first signals respectively, and the first electronic device is held by a user, the indoor navigation method comprising:
obtaining a destination location in the first place by the first electronic device;
detecting a second signal transmitted by a second signal transmitting device in the first signals by the first electronic device;
obtaining a first path from a first location adjacent to the second signal transmitting device to the destination location by the first electronic device according to the second signal and the destination location; and
outputting the first path to inform the user of the first electronic device by the first electronic device.

9. The indoor navigation method as claimed in claim 8, wherein before the step of obtaining the first path from the first location adjacent to the second signal transmitting device to the destination location, the indoor navigation method further comprises:
obtaining a plurality of first location information of the first signal transmitting devices by the first electronic device, and displaying a plurality of second locations of the first signal transmitting devices deployed at the first place according to the first location information.

10. The indoor navigation method as claimed in claim 9, wherein the indoor navigation system further comprises a server, and the indoor navigation method further comprises:
storing the first location information of the first signal transmitting devices by the server; and
obtaining the first location information of the first signal transmitting devices from the server by the first electronic device.

11. The indoor navigation method as claimed in claim 8, wherein the first path passes through a plurality of third signal transmitting devices in the first signal transmitting devices.

12. The indoor navigation method as claimed in claim 8, further comprising:
detecting a third signal transmitted by a fourth signal transmitting device in the first signals by the first electronic device;
determining whether the user moves along the first path by the first electronic device according to the third signal;
when the user does not move along the first path, obtaining a second path from a third location adjacent to the fourth signal transmitting device to the destination location by the first electronic device according to the third signal and the destination location; and
outputting the second path to inform the user of the first electronic device by the first electronic device.

13. The indoor navigation method as claimed in claim 8, further comprising:
displaying a push message by the first electronic device according to the second signal.

14. The indoor navigation method as claimed in claim 8, wherein the first signal is a beacon signal.
